(19) United States
(12) Patent Application Publication
(10) Pub. No.: US 2010/0236432 A1
(43) Pub. Date: Sep. 23, 2010

(54) Process for Producing Security Papers, Intaglio Printing Press for Implementing Said Process, and Security Paper Produced According to Said Process

(75) Inventors: Jean-Francois Foresti, Ecublens (CH); Johannes Georg Schaede, Wurzburg (DE); Vincent Moreau, Lausanne (CH)

Correspondence Address: CROMPTON, SEAGER & TUFTE, LLC, 1221 NICOLLET AVENUE, SUITE 800, MINNEAPOLIS, MN, 55403-2420, US

(73) Assignee: KBA-GIORI S.A,, Lausanne (CH)

(21) Appl. No.: 12/294,297

(22) PCT Filed: Mar. 29, 2007
(86) PCT No.: PCT/IB2007/000845

§ 371 Date: Sep. 24, 2008

(30) Foreign Application Priority Data
Apr. 4, 2006 (EP) 06007154.5

(51) Int. Cl. B41F 9/10; B41M 1/10; B42D 15/00

(52) U.S. Cl. 101/167; 101/170; 283/57

(57) ABSTRACT

There is described process for producing security papers, in particular banknotes, comprising the step of sealing the surface of the security papers by applying a protective pattern on the surface of the security paper, which sealing comprising printing the security papers by intaglio printing using an intaglio printing plate with engraved areas such that at least 80% of the whole surface of each security paper is covered with embossed intaglio patterns produced by engraved areas of the intaglio printing plate which are inked or with a combination of embossed intaglio patterns and flat intaglio patterns, which flat intaglio patterns are produced by unengraved areas of the intaglio printing plate which are inked after wiping of the intaglio printing plate, at least a part of the embossed intaglio patterns and/or flat intaglio patterns being printed with a transparent or semi-transparent intaglio ink. The transparent or semi-transparent intaglio ink is applied in engraved areas and/or unengraved areas of the intaglio printing plate so as to seal substantially the whole surface of the security papers with a protective pattern composed of intaglio patterns. Also described are intaglio printing presses for implementing the said process and the resulting security papers.

### TECHNICAL FIELD OF THE INVENTION

The invention relates to a process for producing security papers, especially banknotes, to an intaglio printing press for implementing such process, and to a security paper produced according to such a process.

### BACKGROUND OF THE INVENTION

The common practice in the security printing industry is to associate more than one printing processes on a same security paper, that is to say to submit security papers to a plurality of different printing/application processes so as to render forgery more difficult. As examples of usual printing/application processes used in the security printing industry, especially for the production of banknotes, one can cite offset printing, silk-screen printing, foil application, intaglio printing, numbering, as well as flexographic printing. Intaglio printing is in particular used in the industry for creating highly distinctive relief and embossed features. Such intaglio features are highly resistant to counterfeiting as they necessitate specific equipment to be produced and cannot be easily copied using equipment readily available to counterfeiters. Intaglio printing is commonly used to print only parts of the surface of banknotes (or security papers in general) so as to create distinctive intaglio patterns such as portraits, guilloche patterns, vignettes, latent images, as well as other specific intaglio security features exploiting the characterizing relief/tactile effect of intaglio printing. The remaining areas of the banknotes are commonly printed, prior to intaglio printing, with a multi-colour offset background. The banknotes may optionally be provided with optically-variable ink patterns (or OVI patterns), using silk-screen printing technology, and/or with optically-variable devices (or OVD's), such as holograms, using foil application technology. Banknotes are further numbered with serial numbers and/or signatures, using letterpress printing technology. Varnishing of the banknotes using offset or, preferably, flexographic printing technology can optionally be performed before or after numbering of the banknotes.

The above mentioned intaglio printing process is usually implemented with a sheet-fed or web-fed intaglio printing press. A typical sheet-fed intaglio printing press is for instance disclosed in European patent application EP 0 406 157. It comprises a plate cylinder with several printing plates, an impression cylinder, a wiping device and an inking system comprising an ink-collecting cylinder (also referred to as an Orlof cylinder) having an elastic surface interacting with the printing plates. The inking system further comprises selective inking cylinders contacting the periphery of the ink-collecting cylinder and having relief portions corresponding to the zones of the printing plates to be inked in the various desired colours. The selective inking cylinders are each inked in the corresponding colours by suitable inking devices. Each printing plate exhibits engraved areas corresponding to the areas on the security papers which are meant to be provided with an intaglio imprint (such as a portrait, guilloche patterns, etc.) as well as non-engraved areas which will not carry any ink onto the security papers. The engravings on the printing plates may comprise any suitable combination of deep and fine intaglio cuts in order to produce the desired intaglio patterns on the security papers.

It will be understood that the printing plates are each inked in the desired colours by means of the inking system, excess ink being wiped off the non-engraved areas of the printing plates under the action of the wiping device which typically includes a so-called wiping roller rotating in the same direction as the plate cylinder. Intaglio printing actually occurs at the printing nip between the plate cylinder and the impression cylinder under the action of greater pressure, thereby transferring the coloured inks from the engravings of the printing plates to the sheets carried by the impression cylinder and creating embossed structures which are characteristic of the intaglio printing process.

Other configurations of intaglio printing machines are possible. Such other examples might for instance be found in European patent applications EP 0 091 709, EP 0 415 881, EP 0 563 007, EP 0 683 123, EP 0 873 866, EP 1 400 353, EP 1 602 482, EP 1 602 483 and international application WO 2005/077656.

Banknotes and like security documents are typically provided with intaglio imprints only on a portion of their surface, the remaining part of the surface thereof being provided with other printed or applied patterns, such as offset prints, silk-screen prints, OVD's, typographic elements (such as serial numbers and signatures) or are merely left blank (such as in regions where watermarks are provided). As mentioned, a varnish or lacquer might be applied on the surface of the documents or only on part thereof. Such security papers exhibit a satisfactory visual appearance, a good physical resistance to soiling, and a substantial level of resistance against counterfeiting. However, there is a constant need for improving these features, especially increasing the physical resistance of the documents as well as increasing the anti-counterfeiting resistance of the documents.

International Application WO 01/03951 discloses a security document with a raised intaglio-printed image. The substrate of the security document is provided with a smooth highly reflective layer having a reflectivity of at least 60 gloss units, and the raised printed image is applied onto this reflective layer by intaglio printing using a transparent or translucent intaglio ink. The reflective layer can be applied on the substrate in the form of individual patches or over the whole surface of the security document. This application is performed by gravure printing, which printing process is to be distinguished from the intaglio printing process used to create the raised printed image. As a matter of fact, gravure printing uses gravure cylinders having a regular pattern (or screen) of individual cells as mentioned in WO 01/03951. In contrast to intaglio printing, gravure printing is performed with considerably lower printing pressure and does not produce any embossing on the surface of the printed material (see for instance the Handbook of Print Media, H. Kipphan, Springer Verlag, 2001, ISBN 3-540-67326-1). In other words. WO 01/03951 teaches a security document which requires two successive printing processes, namely gravure printing in order to apply the reflective layer and subsequent intaglio printing in order to produce the raised printing image over the reflective layer. In addition, while the reflective layer could cover the whole surface of the security document, the raised printed image covers only a small portion of the surface of the document and does not therefore provide any noticeable sealing effect of the surface of the document.

U.S. Pat. No. 5,449,200 discloses a security paper comprising a resinous substrate sheet on which indicia are printed and paper sheets laminated on either side of the resinous substrate sheet. The indicia printed on the resinous substrate sheet are preferably printed using a transparent ink. More precisely, the indicia are printed by gravure printing using a rotogravure printing cylinder. Again, the gravure printing process does not produce any embossing on the document and is to be distinguished from the intaglio printing process. Furthermore, according to U.S. Pat. No. 5,449,200, a sealing effect is ensured by the laminated sheets on either side of the resinous substrate sheet. As such, the purpose of the indicia is not to provide any sealing of the surface of the document. In any case, the indicia cover only a small portion of the surface of the resinous substrate sheet.

U.S. Pat. No. 1,299,484 discloses a security document which is produced as a result of two successive intaglio printing steps. During a first intaglio printing step, a first set of impressions is printed so as to largely cover the surface of the paper using a substantially white or practically invisible pigment. This first set of impressions consists of a network of intersecting lines. During the second subsequent intaglio printing step, a second set of impressions is printed above the first set of impressions, using this time a visible ink. As a result, the second set of impressions is superimposed on top of the first impressions and are deformed by the underlying first set of impressions. A disadvantage of this solution thus resides in that two printing steps are required to produce the security document. As freshly printed sheets printed by intaglio printing have typically to be dried or rest for a certain duration, this solution considerably increase production times. Furthermore, subjecting the same side of the security document to two successive intaglio printing steps is detrimental as each intaglio step considerably affects the structure and shape of the printed material. Lastly, the visible appearance of the second set of impressions is greatly degraded by the underlying first set of impressions.

British patent GB 803,546 and U.S. Pat. No. 3,390,631 both describe combined intaglio and letterpress printing presses wherein an additional inking system is used to ink the intaglio printing plate after wiping thereof by the wiping system.

More precisely, according to British patent GB 803,546, the additional inking system comprises a number of letterpress plate cylinders each carrying a letterpress plate for forming a corresponding portion of a background of a security document. The letterpress plate cylinders all cooperate with a common letterpress ink transfer cylinder which contacts the unengraved surface of the intaglio printing plate at a location downstream of the wiping system, before the location where the paper is printed. Thanks to this solution, both the intaglio patterns and a background are printed at the same time. Document GB 803,546 is however silent about the amount of coverage of the resulting intaglio patterns. It is however apparent that only a small portion of the surface of the intaglio printing plate is engraved.

According to U.S. Pat. No. 3,390,631, a portion of the engraved areas of the intaglio printing plate is inked prior to wiping, a remaining portion of the engraved areas being left empty from any ink. After wiping and before printing, the unengraved areas surrounding the remaining non-inked portion of the engraved areas is inked by means of the additional inking system. The result is an ink pattern having two portions in perfect register, one in negative representation, and the other in positive representation. A problem with this solution resides in the fact that ink will inevitably penetrate into the non-inked engraved areas of the intaglio printing plate as a consequence of the printing operation even if the additional inking system is as such designed to avoid such penetration of ink into the unengraved areas of the intaglio printing plate. The quality of print thus quickly degrades with such a solution. Further, the additional inking system is basically intended to ink regions of reduced areas of the intaglio printing plate, such as spaces intended to receive indications which must not be falsified.

### SUMMARY OF THE INVENTION

An aim of the present invention is thus to provide a process for producing security papers which improves the physical resistance thereof as well as increases the resistance of these security papers to counterfeiting.

Another aim of the present invention is to provide a process for producing security papers which remains economical, i.e. as much as possible makes use of existing technologies.

Still another aim of the present invention is to provide a process that can readily be implemented on existing printing and processing equipment, which equipment however remains mostly inaccessible to counterfeiters.

These aims are achieved thanks to the process defined in independent claim 1 which comprises the step of sealing the surface of the security papers by applying a protective pattern on the surface of the security papers, which step comprises printing the security papers by intaglio printing using an intaglio printing plate with engraved areas such that at least 80% of the whole surface of each security paper is covered with embossed intaglio patterns produced by engraved areas of the intaglio printing plate which are inked or with a combination of embossed intaglio patterns and flat intaglio patterns, which flat intaglio patterns are produced by unengraved areas of the intaglio printing plate which are inked after wiping of the intaglio printing plate, at least part of said embossed intaglio patterns and/or flat intaglio patterns being printed with a transparent or semi-transparent intaglio ink.

The advantages of the present invention are multiple:
firstly, it improves the resistance of the security papers from a physical point of view because substantially the whole surface (i.e. at least 80%) of the security paper is covered by intaglio imprints. Indeed, the resistant intaglio ink layers, together with the inherent calendering effect of intaglio printing, provide increased protection of the whole surface of the security papers;
secondly, all-over intaglio printing of the security papers increases the security thereof, the characterizing embossed and tactile structure of the embossed intaglio patterns being readily noticeable by the touch of a finger. Such features being difficult to reproduce without a proper equipment, forgery is accordingly made much more complicated;
thirdly, the visual appearance of the security papers is not as such negatively affected as the usually non-intaglio-printed regions of the security papers are overprinted using a transparent or semi-transparent intaglio ink;
fourthly, production of the security papers does not require use of equipment other than that already commonly used.

From a general point of view, intaglio printing of the security paper on approximately the whole surface thereof has the effect of “sealing” the security paper, both from the point of view of its physical properties and from the point of view of its resistance to forgery.

Advantageous embodiments and variants of the invention form the subject-matter of the dependent claims.

In particular, according to one embodiment of the invention, intaglio printing is carried out using an intaglio printing plate having engraved areas extending over at least 80% of the whole surface thereof, which intaglio printing plate is inked at least in a portion of the surface thereof with the at least one transparent or semi-transparent intaglio ink to create transparent or semi-transparent embossed intaglio patterns on a corresponding portion of the security papers.

According to a first variant of this embodiment, a first portion of the surface of the intaglio printing plate is inked with at least one visible intaglio ink to create visible embossed intaglio patterns on a corresponding first portion of the surface of the security papers. The remaining portion of the surface of the intaglio printing plate is inked with the at least one transparent or semi-transparent intaglio ink to create transparent or semi-transparent embossed intaglio patterns on a corresponding remaining portion of the surface of the security papers. This variant is particularly advantageous in the context of security papers bearing visible intaglio patterns on at least one face thereof (such as portrait, guilloches, vignettes, etc.). Banknotes in particular, are typically provided with visible intaglio patterns on one side or both sides. In this context, the transparent or semi-transparent intaglio patterns are printed so as to complement the sealing effect already provided by the visible intaglio patterns.

According to another variant of the embodiment, approximately the whole surface of the intaglio printing plate is inked with the at least one transparent or semi-transparent intaglio ink to create transparent or semi-transparent embossed intaglio patterns on approximately the whole surface of each of the security papers. This second variant is advantageous in the context of security papers bearing no visible intaglio patterns on at least one face thereof. As mentioned above, banknotes might be provided with visible intaglio pattern on only one side. In such a case, the transparent or semi-transparent intaglio patterns may accordingly be printed on approximately the whole surface of the other side of the banknotes.

The transparent or semi-transparent embossed intaglio patterns can advantageously be printed so as to have an ink coverage ratio (i.e. the ratio of the surface covered by intaglio ink and of the surface not-covered by intaglio ink) close to 100%. This is particularly feasible as the said intaglio patterns are printed using a transparent or semi-transparent intaglio ink, thereby not affecting the visual appearance to the naked eye of the printed document. According to a preferred variant of this embodiment, the transparent or semi-transparent intaglio patterns may in particular be so-called multi-tone patterns, continuous backgrounds, or stochastic backgrounds, i.e. patterns having a seemingly continuous surface coverage. Multi-tone patterns and continuous backgrounds are typically created by an intimate combination of rectilinear and/or curvilinear lines, the depth and line thickness of which may be modulated or varied to produce the visual effect of a continuously printed surface. On the other hand, stochastic backgrounds are formed of patterns that are distributed randomly over a desired surface. It shall be understood that printing of large surfaces using intaglio printing technology alone typically necessitates the provision of ink retaining areas for restraining the flow of ink on the intaglio printing plates and preventing that the inked is wiped off during wiping of the printing plates. Multi-tone patterns, continuous backgrounds and stochastic backgrounds typically incorporate such ink-retaining areas in the form of appropriate separations between the engravings or partitions within the engravings, such as unengraved dot or line areas.

According to another embodiment of the present invention, intaglio printing is carried out using an intaglio printing plate having engraved areas which do not extend over the whole surface thereof (i.e. extend only over part of the surface). Such intaglio printing plate is inked in at least a remaining unengraved portion of the surface of the intaglio printing plate, after wiping of the surface of the plate, with the at least one transparent or semi-transparent intaglio ink to create transparent or semi-transparent flat intaglio patterns on a corresponding portion of the security papers. According to this embodiment, the transparent or semi-transparent intaglio ink is thus deposited onto the unengraved surface of the intaglio printing plate after wiping, thereby creating a continuous and uninterrupted layer of transparent or semi-transparent intaglio ink that is transferred onto the surface of the security papers as flat intaglio patterns. Advantageously, as inking with the transparent or semi-transparent intaglio ink is carried out after wiping, the transparent or semi-transparent intaglio ink may be deposited in-between the engraved areas of the printing plate, for instance between each engraved lines of a portrait. The result is a security paper which is completely covered by intaglio ink.

According to still another embodiment of the present invention, at least part of the transparent or semi-transparent intaglio patterns are printed with an intaglio ink that fluoresces under UV or IR radiation. Preferably, the said at least part of the transparent or semi-transparent intaglio patterns printed with fluorescent intaglio ink forms a determined pattern recognizable under UV or IR radiation. In this context, the determined pattern might be engraved in the intaglio printing plate and inked with fluorescent intaglio ink prior to wiping. Alternatively, the determined pattern might be created by selective deposition of fluorescent intaglio ink, after wiping, on an unengraved portion of the intaglio printing plate. Combinations are also possible wherein the fluorescent pattern is formed using an appropriate engraved pattern in the intaglio printing plate which is inked prior to wiping, and a background layer of transparent or semi-transparent intaglio ink is deposited after wiping on the unengraved surface of the printing plate.

The transparent or semi-transparent intaglio ink may advantageously be applied after wiping of the intaglio printing plate or plates, adequately using a inking device applying the intaglio ink directly onto the intaglio printing plate or plates. This solution is particularly advantageous in the context of the application of a transparent or semi-transparent intaglio ink containing fluorescent pigments, as the said pigments will not be subjected to the wiping operation (which operation could physically affect the structure of the pigments themselves). In addition, ink contamination problems will be reduced to a minimum as the pigment-containing ink is applied using a separate inking device and after all the other inks have already been applied onto the printing plates.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIG. 1 is a schematic illustration of an exemplary security paper produced according to the process of the present invention;

FIGS. 2a, 2b and 2c are exemplary designs for the realisation of the transparent intaglio patterns;

FIG. 3 represents a first embodiment of an intaglio printing press for implementing the process of the invention using an ink-collecting system (or indirect inking system) for inking the intaglio printing plates; and

FIG. 4 represents a second embodiment of an intaglio printing press for implementing the process of the invention using the ink-collecting system of FIG. 2 as well as an additional direct inking device for inking the intaglio printing plates after wiping thereof by the wiping system.

### DESCRIPTION OF THE INVENTION

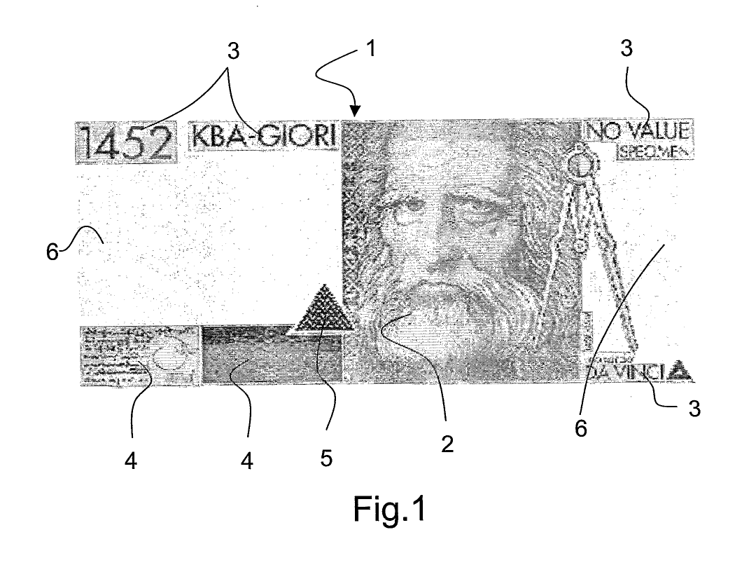

FIG. 1 schematically illustrates an exemplary security paper 1 produced according to the present invention. A first portion of the surface of the security paper is provided, as is usual in the art, with first intaglio patterns 2, 3, 4, 5 which are visible to the naked eye. Such first intaglio patterns include in this example a portrait 2 and various other intaglio patterns 3, 4, 5 comprising alpha-numerical patterns 3 (e.g. “1452”, “KBA-GIORI”, “NO VALUE”, “SPECIMEN”, “Leonardo DA VINCI”) as well as guilloches or vignettes 4 and an intaglio OVI pattern. According to the invention, the security paper 1 further comprises a set of second intaglio patterns 6 provided on the remaining portion of the security paper 1 (which remaining portion is usually not printed with any intaglio imprints). These second intaglio patterns 6 are printed exclusively with transparent or semi-transparent intaglio ink, thus remaining substantially invisible to the naked eye. Intaglio patterns 2 to 5 and 6 jointly extend over approximately the whole surface of the security paper 1 and form a protective pattern having the effect of sealing the surface of the security paper 1.

For the purpose of explanation, FIG. 1 shows rectangular or polygonal areas superimposed on the various intaglio patterns 2 to 6. These rectangular or polygonal areas are meant to schematically illustrate the various inked areas created by the corresponding chablon cylinders (or selective inking cylinders) that are used to ink the engravings on the intaglio printing plate with the desired colours. It is to be understood that each depicted rectangular or polygonal area in FIG. 1 corresponds to a relief area on a corresponding one of the chablon cylinders (there being as many such relief areas on the chablon cylinders as there are regions on the printing plate to be inked). The surface of the intaglio printing plate is accordingly covered almost completely by visible and transparent or semi-transparent intaglio inks. It is only after the wiping operation, that ink is wiped off the non-engraved areas of the printing plate, such as around the alpha-numerical patterns 3, between the lines of the portrait 2, etc.

In the example of FIG. 1, the security paper has a surface of approximately 12′000 square millimeters. Looking at the surface inked by the chablon cylinders, approximately 7′000 square millimeters are inked in this example with visible intaglio ink (i.e. the areas corresponding to patterns 2 to 5) and approximately 5′000 square millimeters are inked with transparent or semi-transparent intaglio ink (i.e. the areas corresponding to patterns 6). The above repartition between visible inked areas and transparent or semi-transparent inked areas will of course depend on the particular design of the security paper.

The effective ink coverage ratio on the security paper 1, i.e. the ratio between the surface of the security paper 1 that is covered with intaglio ink and the surface of the security paper 1 that is not covered by any intaglio ink, depends on the design and spatial density or frequency of the engravings. Looking at intaglio patterns 2 to 5 as a whole, the effective ink coverage ratio (or mean ink coverage ratio) is of the order of 30%. Intaglio patterns 2 to 5 however have individual ink coverage ratios that can vary from 25% (such as in the case of alpha-numerical patterns 3) to 85% (such as in the case of the intaglio OVI pattern 5). As a general rule, the overall ink coverage ratio of the visible intaglio patterns can be estimated to lie between 25% to 85%, this depending on the individual designs provided on the security paper. In contrast, the ink coverage ratio of the transparent or semi-transparent intaglio patterns 6 can be made much higher, even close to 100%, as there is strictly speaking no “visual” restrictions with respect to the design of these patterns. As a consequence, the overall ink coverage ratio of the transparent intaglio patterns can be comprised within the range of 25% to 100%, advantageously close to 100% so as to provide the best possible sealing effect.

The transparent or semi-transparent intaglio patterns may obviously be overprinted on previously-printed or applied patterns, like offset backgrounds, silk-screen patterns (such as OVI prints), stamped patches or foils (such as OVD's, holograms or the like), etc. In such case, the background patterns remain visible through the transparent or semi-transparent intaglio patterns 6 and the overall visual aspect of the security paper remains almost unchanged.

Within the scope of the present invention, it will be appreciated that the advantageous sealing effect resulting from the invention will be achieved if intaglio imprints are printed on at least 80% of the whole surface of the security paper. There might be situations where it is desired not to provide any intaglio overprints on specific regions of the security paper. This can in particular be the case in regions provided with patterns having properties that could be impaired by intaglio overprints (such as the optical properties of OVD's or holograms for example). Not providing such areas with any intaglio overprints would not as such be much detrimental to achieving the desired sealing effect.

Furthermore, in cases where security papers are printed on only one face thereof with visible intaglio patterns (such as portraits, guilloches, vignettes, etc.), the other side of the security papers might be completely covered with transparent or semi-transparent intaglio patterns.

It will be understood that the sealing effect of transparent intaglio patterns 6 will be the greatest if the ink coverage ratio of said patterns is maximized, i.e. close to 100%. Various designs might be envisaged to achieve this goal. According to a particularly advantageous variant, the transparent intaglio patterns 6 may in particular be realised as so-called multi-tone patterns, continuous backgrounds or stochastic backgrounds, i.e. patterns having a seemingly continuous surface coverage. Such multi-tone patterns and backgrounds are typically created by an intimate combination of rectilinear and/or curvilinear lines, the depth and line thickness of which may be modulated or varied to produce the visual effect of a continuously printed surface. On the other hand, stochastic backgrounds comprise randomly distributed patterns, such as dots, curvilinear patterns or the like.

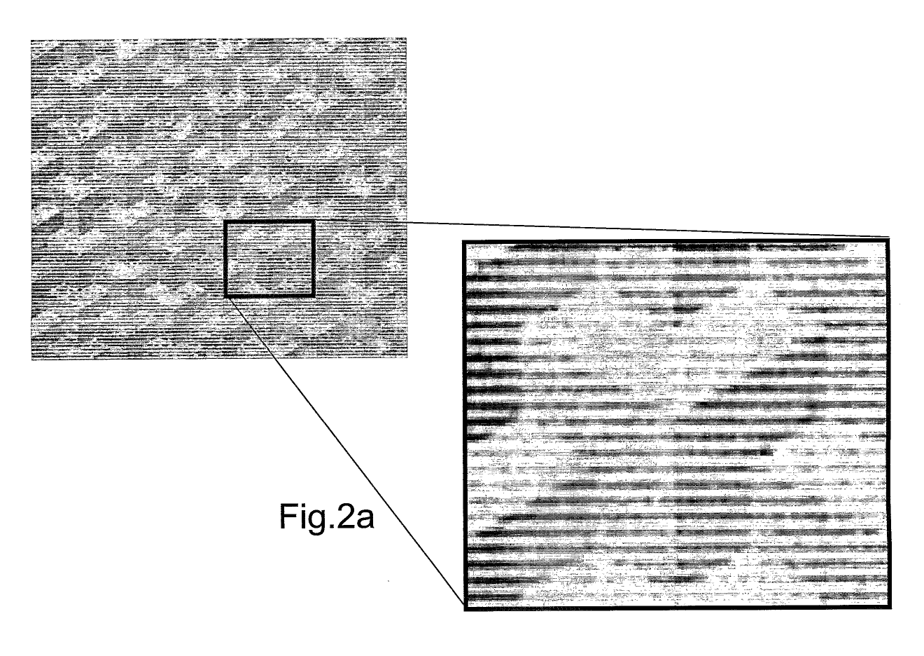

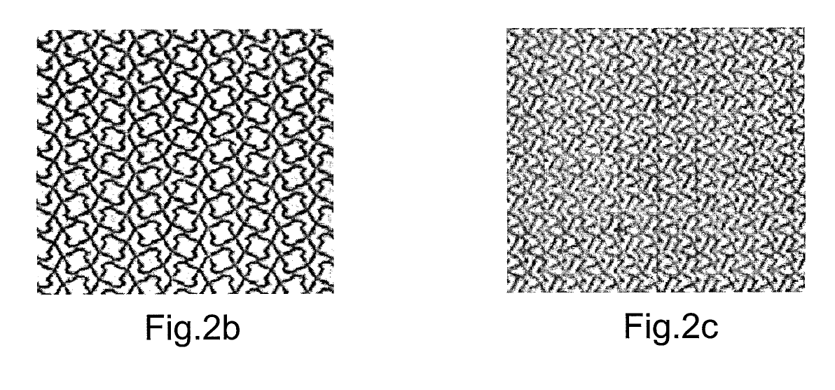

FIG. 2a is an exemplary illustration of a multi-tone pattern consisting of a series of parallel lines the depth (or intensity) of which is modulated to create any desired representation, here 3D-like geometrical shapes. The ink coverage ratio of the pattern illustrated in FIG. 2a is close to 100%, the alternating depth/intensity of each adjacent line enabling to fulfil the necessary ink retaining function for intaglio printing. One will of course understand that the illustration of FIG. 2a shows varying tones that will not as such be readily visible to the naked eyed once printed with transparent or semi-transparent intaglio ink. A visual effect might however be detected under specific illumination conditions. Moreover, a more striking visual effect might be created using an intaglio ink comprising pigments that fluoresce under UV or IR radiations, the varying density of the transparent pigment-containing ink producing varying fluorescent intensities. The illustration of FIG. 2a is of course given as a non-limiting example, simpler solutions being possible.

FIGS. 2b and 2c show two other possible designs for the realisation of the transparent or semi-transparent intaglio patterns 6. In these two examples, the patterns consist of a network of curvilinear lines extending over the printed surface. While the effective ink coverage ratio of these two examples is less that that of the pattern shown in FIG. 2a, such solution nevertheless permit to achieve the desired sealing effect. It will be understood that the greater the spatial density of lines, the better the sealing effect will be. In any case, one should further understand that even though regions bearing no intaglio ink are still present, those regions will nevertheless be protected or sealed by the neighbouring ink-bearing regions that are embossed as the result of the intaglio printing process. It will be understood that other solutions consisting simply of a network of rectilinear lines or a combination of rectilinear and curvilinear lines are also possible.

As already mentioned hereinabove, at least part of the transparent or semi-transparent intaglio patterns might be printed with a transparent or semi-transparent intaglio ink that fluoresces under UV or IR radiations. Either the whole transparent or semi-transparent intaglio patterns might be printed with such an ink or only part thereof, this requiring the use of at least two separate transparent or semi-transparent intaglio inks. In that context, the part of the transparent intaglio patterns that is printed with fluorescent intaglio ink may advantageously form a determined pattern recognizable under UV or IR radiation.

Inking of the intaglio printing plate with transparent or semi-transparent intaglio ink might be performed prior to wiping of the printing plate, as is usual in the art, or alternatively, after wiping of the intaglio printing plate, before printing of the security papers. In this latter case, the transparent or semi-transparent intaglio ink can advantageously be applied directly onto the intaglio printing plate by means of a direct inking device. This latter solution is particularly advantageous in the context of the application of an intaglio ink containing fluorescent pigments, as the said pigments will not be subjected to the wiping operation (which operation could physically affect the structure of the pigments themselves). This will furthermore reduce ink contamination problems to a minimum as the pigment-containing ink is applied using a separate inking device and after all the other inks have already been applied onto the printing plate.

Inking of the intaglio printing plate after wiping also has the advantage of enabling an inking of the unengraved areas of the intaglio printing plate. Within the scope of the present invention, it is thus possible to apply transparent or semi-transparent intaglio ink on the unengraved surface of the printing plate so as to transfer a uniform layer of transparent or semi-transparent intaglio ink on substantially the whole surface of the security papers. The result is accordingly a security paper provided with a combination of embossed and flat intaglio patterns, i.e. patterns created respectively by corresponding engraved areas and unengraved areas of the printing plate.

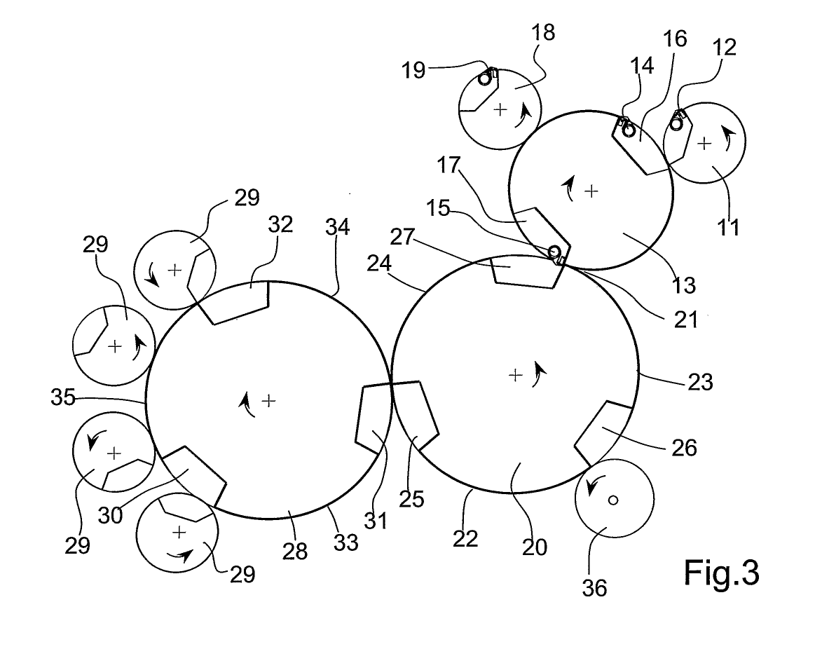

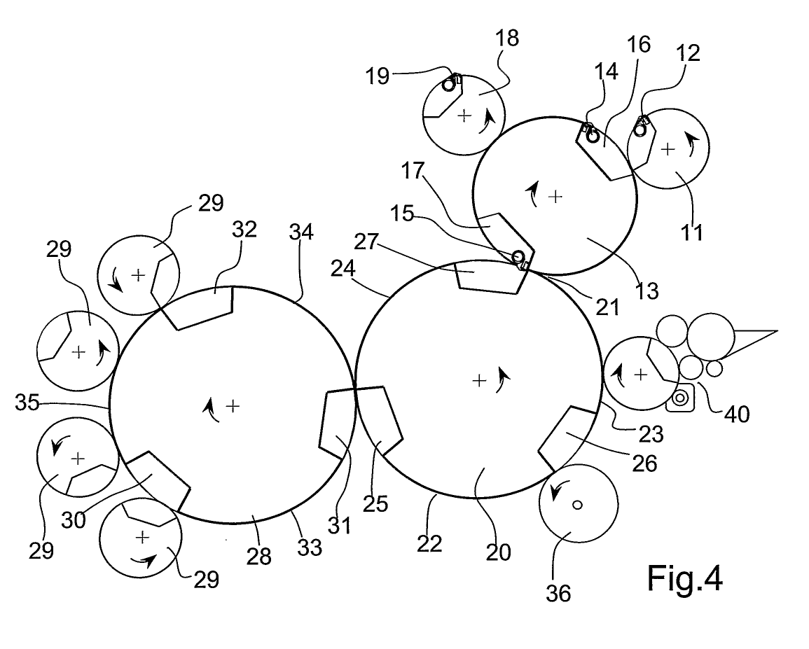

The process according to the instant invention can be implemented in different ways, using existing intaglio printing presses or slightly modified versions thereof. FIGS. 3 and 4 illustrate two possible examples of such printing presses, where the same references are used to designate the same elements.

In both examples, the press comprises a transfer cylinder 11 with grippers 12 disposed in a pit of the transfer cylinder 11 for feeding sheets to be printed, an impression cylinder 13 on which the sheets are held by two sets of grippers 14, located in corresponding cylinder pits 16, 17 (the impression cylinder 13 being a two-segment cylinder) and a delivery chain cylinder 18 with grippers 19 for taking away the printed sheets from the impression cylinder 13. Sheets are fed from a feeding station (not shown) to the transfer cylinder 11 and onto the impression cylinder, and, following printing, delivered to a sheet delivery system (not shown) by means of the delivery chain cylinder 18.

The impression cylinder 13 cooperates with a plate cylinder 20. Sheets carried by the impression cylinder 13 are printed at the printing nip 21 formed between the impression cylinder 13 and the plate cylinder 20.

The plate cylinder 20 carries a plurality of intaglio printing plates (three in the illustrated examples) which are schematically identified by references 22, 23 and 24. The intaglio printing plates are mounted on the plate cylinder 20 by means of adequate plate clamping devices, as such known in the art, which are located in cylinder pits 25, 26 and 27.

The intaglio printing plates 22, 23 and 24 are inked by an inking system comprising, in this example, an ink-collecting cylinder (or Orlof cylinder) 28 and a plurality of selective inking cylinder (or chablon cylinders) 29, each selective inking cylinder 29 being inked in at least one corresponding colour by an associated inking device (not illustrated). As is known in the art of intaglio printing, the selective inking cylinders 29 bear chablons with relief patterns corresponding to the areas on the intaglio printing plates 22, 23, 24 to be inked in the desired colours. The ink-collecting cylinder 28 bears rubber blankets 33, 34 and 35 which are held onto the surface of the cylinder by appropriate holding means disposed in corresponding cylinder pits 30, 31, 32.

A wiping unit 36 is further provided downstream of the inking system for wiping excess ink off the surface of the intaglio printing plates 22, 23, 24. Such wiping unit 36 typically comprises a wiping roller rotating against the surface of the plate cylinder 20.

It will be appreciated that the machine configurations illustrated in FIGS. 3 and 4, at least as far as the cylinder configurations are concerned, basically correspond to that disclosed in European patent application EP 0 406 157. Other machine configuration might be envisaged within the scope of the present invention. Other configurations might for instance be found in European patent applications EP 0 091 709, EP 0 415 881, EP 0 563 007, EP 0 683 123, EP 0 873 866, EP 1 400 353, EP 1 602 482, EP 1 602 483 and international application WO 2005/077656.

Within the scope of the present invention, transparent or semi-transparent intaglio ink is to be applied onto the surface of the intaglio printing plates. To this end, in the machine configuration of FIG. 3, at least one of the selective inking cylinders 29 (such as the lowest cylinder in FIG. 3, i.e. the first cylinder in contact with cylinder 28 with respect to the direction of rotation of cylinder 28) is inked with transparent or semi-transparent intaglio ink and the surface thereof is structured in such a way that the intaglio ink is transferred onto the intaglio printing plates in regions corresponding to the transparent intaglio patterns to be printed. In this example, the intaglio printing plates 22, 23, 24 each have, in contrast to usual intaglio printing plates, engraved areas covering approximately the whole surface thereof.

Alternatively, a direct inking system with a selective inking cylinder contacting directly the surface of the plate cylinder 20, between the ink-collecting cylinder 28 and the wiping unit 36, might be provided to apply transparent or semi-transparent intaglio ink directly onto the surface of the intaglio printing plates. An intaglio printing press with combined indirect and direct inking is for instance disclosed in European patent application EP 0 091 709. Further, the inking system may only include direct inking devices and no ink-collecting cylinder.

FIG. 4 illustrates still another variant where an inking device 40 is located after the wiping unit 36 so as to directly ink the surface of the intaglio printing plates 22, 23, 24, as is known from European patent application EP 1 602 483. Using the inking device 40 of FIG. 4 to apply transparent or semi-transparent intaglio ink is particularly advantageous in the context of the application of an ink containing fluorescent pigments, as the said pigments will not be subjected to the wiping operation (which operation could physically affect the structure of the pigments themselves). In addition, ink contamination problems will be reduced to a minimum as the pigment-containing intaglio ink is applied using an inking device that is separate from the other inking system 28, 29 and after all the other inks have already been applied onto the printing plates 22, 23, 24.

Further, in the context of the example of FIG. 4, unengraved areas of the intaglio printing plates 22, 23, 24 are inked by the inking device 40. Accordingly, the printing plates 22, 23, 24 do not as such have to be provided with engraved areas in the regions meant to be inked by transparent or semi-transparent intaglio ink.

In addition, in contrast to the inking system 28, 29 with its chablon cylinders 29, the inking device 40 does not a such require a patterned cylinder for the application of ink. The inking device 40 may indeed be adapted to apply ink on substantially the whole surface of the intaglio printing plates 22, 23, 24, such that the unengraved areas which are contiguous to the engraved areas (such as unengraved areas in-between the engraved lines of the portrait 2 of FIG. 1, the unengraved areas immediately surrounding the alpha-numerical patterns 3 of FIG. 1, etc.) are also inked. Thanks to the machine configuration of FIG. 4, the overall ink coverage ratio of each security paper can be close to 100%. The inking device 40 may nevertheless use a patterned inking cylinder so as to restrict the application of transparent or semi-transparent intaglio ink on selected regions of the intaglio printing plate if necessary or required.

One will also understand that one can use both the inking system 28, 29 and the inking device 40 of FIG. 4 to apply at least two transparent or semi-transparent intaglio inks in order to create more complex intaglio patterns using combination of transparent or semi-transparent intaglio inks, such as a first ink containing fluorescent pigment and a second ink having a neutral effect under UV or IR radiation.

The intaglio printing plates necessary for implementing the invention can advantageously be produced using the engraving principles described in international application WO 03/103962, the content of which is incorporated by reference in the present application. This application discloses a method of manufacturing an engraved plate for intaglio printing, wherein a non engraved plate is submitted to a programmed engraving process by a computer-controlled engraving tool based on three-dimensional guiding pixel data of a master depth-map representing a whole sheet to be printed. The master depth-map is generated by at least one computer stored original depth-map, which original depth-map consists of a three-dimensional raster image of at least a part of the security paper. The intaglio printing plate is thus engraved as a result of a plurality of elementary engraving steps associated to the three-dimensional pixel data. Due to its pixel-by-pixel approach, this engraving process is particularly advantageous in the context of the present invention, as substantially the whole surface of the intaglio printing plates can be engraved in comparatively less time than with conventional vector-based engraving processes whereby each engraved area is engraved one after the other. Multi-tone patterns, continuous backgrounds and stochastic backgrounds can in particular be engraved very easily and quickly thanks to the principle of WO 03/103962.

The present inventive concept can also be implemented using variants of intaglio printing. Such a variant is for instance described in European patent application EP 0 619 192 which combines on a same printing plate the properties of intaglio printing and letterpress printing.

Although the process of the present invention has been described in connection with the printing press configurations of FIGS. 3 and 4, it shall again be understood that various other intaglio printing presses could be used to implement the present invention, without departing from the scope of the annexed claims.

Moreover, any adequate inking device can be used to apply the required transparent or semi-transparent ink. For example, a silk-screen inking unit as disclosed in International application WO 01/54904 and European patent application EP 1 486 328 could be used to apply these inks.

1. A process for producing security papers, in particular banknotes, comprising the step of sealing the surface of the security papers by applying a protective pattern on the surface of the security papers,
wherein the step of sealing the surface of the security papers comprises printing the security papers by intaglio printing using an intaglio printing plate with engraved areas such that at least 80% of the whole surface of each security paper is covered with embossed intaglio patterns produced by engraved areas of the intaglio printing plate which are inked or with a combination of embossed intaglio patterns and flat intaglio patterns, which flat intaglio patterns are produced by unengraved areas of the intaglio printing plate which are inked after wiping of the intaglio printing plate, at least a part of the embossed intaglio patterns and/or flat intaglio patterns being printed with a transparent or semi-transparent intaglio ink.

2. The process according to claim 1, wherein the step of printing the security papers by intaglio printing includes providing an intaglio printing plate having engraved areas extending over at least 80% of the whole surface thereof and inking at least a portion of the surface of the intaglio printing plate with the at least one transparent or semi-transparent intaglio ink to create transparent or semi-transparent embossed intaglio patterns on a corresponding portion of the security papers.

3. The process according to claim 2, wherein a first portion of the surface of the intaglio printing plate is inked with at least one visible intaglio ink to create visible embossed intaglio patterns on a corresponding first portion of the surface of the security papers and wherein a remaining portion of the surface of the intaglio printing plate is inked with the at least one transparent or semi-transparent intaglio ink to create transparent or semi-transparent embossed intaglio patterns on a corresponding remaining portion of the surface of the security papers.

4. The process according to claim 2, wherein approximately the whole surface of the intaglio printing plate is inked with the at least one transparent or semi-transparent intaglio ink to create transparent or semi-transparent embossed intaglio patterns on approximately the whole surface of each of the security papers.

5. The process according to claim 2, wherein an ink coverage ratio of the transparent or semi-transparent intaglio patterns is of the order of 25% to 100%.

6. The process according to claim 5, wherein the transparent or semi-transparent intaglio patterns are intaglio patterns having an ink coverage ratio close to 100%.

7. The process according to claim 2, wherein the transparent or semi-transparent intaglio patterns are multi-tone patterns, continuous backgrounds or stochastic backgrounds.

8. The process according to claim 3, wherein the transparent or semi-transparent intaglio patterns comprise a network of rectilinear and/or curvilinear lines extending over the remaining portion.

9. The process according to claim 1, wherein the step of printing the security papers by intaglio printing includes inking at least a portion of the surface of an intaglio printing plate with the at least one transparent or semi-transparent intaglio ink prior to wiping of the surface of said intaglio printing plate so that the transparent or semi-transparent ink is transferred onto the surface of the security papers only in regions corresponding to engraved areas of the intaglio printing plate.

10. The process according to claim 1, wherein the step of printing the security papers by intaglio printing includes inking at least a portion of the surface of an intaglio printing plate with the at least one transparent or semi-transparent intaglio ink after wiping of the surface of said intaglio printing plate so that the transparent or semi-transparent ink is transferred onto the surface of the security papers in regions corresponding to unengraved areas of the intaglio printing plate.

11. The process according to claim 10, wherein substantially all the unengraved areas of the intaglio printing plate are inked with the at least one transparent or semi-transparent intaglio ink.

12. The process according to claim 1, wherein the step of printing the security papers by intaglio printing includes providing an intaglio printing plate having engraved areas which do not extend over the whole surface thereof and inking at least a remaining unengraved portion of the surface of the intaglio printing plate, after wiping of the surface thereof, with the at least one transparent or semi-transparent intaglio ink to create transparent or semi-transparent flat intaglio patterns on a corresponding portion of the security papers.

13. The process according to claim 12, wherein the engraved areas of the intaglio printing plate are inked with at least one visible intaglio ink to create visible embossed intaglio patterns on a corresponding portion of the surface of the security papers.

14. The process according to claim 12, wherein unengraved areas of the intaglio printing plate, in-between the engraved areas of the intaglio printing plate, are inked with the at least one transparent or semi-transparent intaglio ink.

15. The process according to claim 1, wherein at least part of the transparent or semi-transparent intaglio patterns are printed with an intaglio ink that fluoresces under UV or IR radiation.

16. The process according to claim 15, wherein the at least part of the transparent or semi-transparent intaglio patterns printed with fluorescent intaglio ink forms a determined pattern recognizable under UV or IR radiation.

17. An intaglio printing press for implementing the process according to claim 2, wherein the intaglio printing press comprises at least one intaglio printing plate having engraved areas extending over at least 80% of the whole surface thereof and at least one inking device for applying the at least one transparent or semi-transparent intaglio ink in engraved areas of the intaglio printing plate.

18. The intaglio printing press according to claim 17, wherein the at least one inking device is a direct or indirect inking device for inking the at least one intaglio printing plate prior to wiping of the surface thereof by a wiping unit.

19. The intaglio printing press according to claim 17, wherein the at least one inking device is an inking device for inking said the at least one intaglio printing plate after wiping of the surface thereof by a wiping unit.

20. An intaglio printing press for implementing the process according to claim 12, wherein the intaglio printing press comprises at least one intaglio printing plate having engraved areas which do not extend over the whole surface thereof and at least one inking device for applying the at least one transparent or semi-transparent intaglio ink in unengraved areas of the intaglio printing plate,
the at least one inking device being an inking device for inking the at least one intaglio printing plate after wiping of the surface thereof by a wiping unit.

21. A security paper produced according to the process of claim 1, comprising a protective pattern on at least one surface of the security paper for sealing the surface of the security paper, the protective pattern comprising intaglio patterns covering at least 80% of the whole surface of the security paper, which intaglio patterns are produced by intaglio printing using an intaglio printing plate with engraved areas, wherein the intaglio patterns consist of embossed intaglio patterns produced by engraved areas of the intaglio printing plate which are inked or of a combination of embossed intaglio patterns and flat intaglio patterns, which flat intaglio patterns are produced by unengraved areas of the intaglio printing plate which are inked after wiping of the intaglio printing plate, and wherein at least a part of the embossed intaglio patterns and/or flat intaglio patterns are printed with a transparent or semi-transparent intaglio ink.
